(19) United States
(12) Patent Application Publication
(10) Pub. No.: US 2011/0097690 A1
(43) Pub. Date: Apr. 28, 2011

(54) TRAINING SYSTEM FOR SURFING AND METHOD OF USE

(76) Inventor: Franklin Samuel-Cutts PERRY, Wilmington, NC (US)

(21) Appl. No.: 12/787,980

(22) Filed: May 26, 2010

Related U.S. Application Data
(60) Provisional application No. 61/254,059, filed on Oct. 22, 2009.

(51) Int. Cl. G09B 9/02

(52) U.S. Cl. 434/29

(57) ABSTRACT

A training system for surfers includes bases having dimensions to fit a surf board therebetween. The system also includes straps fastened to each of the bases by an elastomeric device such as springs.

### CROSS REFERENCE TO RELATED APPLICATIONS

The present application claims priority to U.S. provisional application Ser. No. 61/254,059, filed on Oct. 22, 2009, the contents of which are incorporated by reference herein in their entirety.

### FIELD OF THE INVENTION

The invention relates to a training system for surfers and method of use. More particularly, the present invention is related to a training system to teach a person to surf in a safe, non-wet environment, and a method of use.

### BACKGROUND

In order to learn or practice to surf, a user places a surfboard on the floor or other solid surface. Once on the floor or other surface, the user will lay on the surfboard, with elbows in an upright position. In this position, the user's legs are flat on the board. The user then prepares to stand upright on the surfboard by kneeling and placing one foot in front of another foot. In this position, the user's hands are no longer in contact with the surfboard. The user then stands on the surfboard.

However, with the surfboard on the floor or other surface, it is not possible for the user to simulate the motion of water during the stages in which the user is attempting to stand upright on the surfboard. This makes it difficult for the user to transition between training and actual use of the surfboard in the water.

Accordingly, there exists a need in the art to overcome the deficiencies and limitations described hereinabove.

### SUMMARY

A training system for surfers comprises bases having dimensions to fit a surf board therebetween; and straps being fastened to each of the bases by a elastomeric device. The portions of the bases are wrapped in padding. The padding is foam. The straps are Polypropylene. The straps are fastened to the elastomeric device. The elastomeric device is one of springs, bungee cords and rubber bands coupled between the straps and the base in order to provide movement of the surf board. The bases are two bases. The straps include a fastening device for securing the surfboard within the bases, and elevated from a surface. The bases include bottom cross bar members and upright members attaching to the bottom cross bar members. The padding is on the bottom cross bar members and upright members. The elastomeric device is mounted between the straps and the upright members of each of the bases. The elastomeric device is secured to the upright members by a fastening mechanism. The straps are adjustable to form loops of different sizes.

In another aspect of the invention, a training system for surfers comprises a plurality of bases having upright members and cross members; a plurality of straps extending between portions of each of the plurality of bases; and a plurality of stretchable devices attaching each of the plurality of straps to the upright members of respective bases. The stretchable device is a spring. The plurality of straps is adjustable. The plurality of bases is two bases, the plurality of straps is two straps and the plurality of stretchable devices is four springs.

In another aspect of the invention, a kit comprises two bases having upright members and cross members; two straps which are configured to extend between portions of each of the plurality of bases; and four springs or elastomeric devices configured to attach each of the straps to the upright members of the bases. The two straps are adjustable straps.

### BRIEF DESCRIPTION OF THE DRAWINGS

The invention will be better understood from the following description, with reference to the attached drawings, which illustrate exemplary embodiments for carrying out the invention, and in which:

FIGS. 1-3 are views of the training system with a surfboard mounted therein;

FIGS. 4 -5 show the training system without the surfboard mounted therein;

FIGS. 6-15 show various views of the training system and components thereof used with the training system;

FIGS. 16-21 show various components of the training system; and

FIGS. 22-28 show a method of using the training system.

### DETAILED DESCRIPTION OF THE INVENTION

The invention relates to a training system for surfers and method of use. More particularly, in a particular embodiment, the present invention is related to a training system to teach a person to surf in a safe, non-wet environment, and a method of use. The training system of the present invention includes twin bases fashioned from, for example, precision-welded 14-gauge 1″ boxed steel tubing, which is then powder-coated both for color and to resist deterioration from exposure to the elements. Once powder-coating is finished, the top and facing edges of the training system can be wrapped in foam or other types of padding for safety, and covered with water-resistant fabric. The bases can vary in width, depth and height, with one illustrative example being about thirty-six inches wide, eighteen inches deep, and thirteen inches high. The bases are extremely sturdy while remaining lightweight.

The training system of the present invention includes suspension straps made of durable material such as, for example, 1.5″ Heavyweight Polypropylene, capable of holding significant weight without damage. Mounts such as, for example, 1.5″ stainless-steel D-rings can be securely fastened to the suspension straps in order to mount the straps to the bases. Springs, bungee cords or other elastic type of material (e.g., rubber bands or other materials/items/devices that can stretch and retract) are coupled between the straps and the base in order to provide movement of the training device, e.g., simulate the surfboard being in water. In one embodiment, the springs can be, for example, Zinc-plated extension springs, each individually capable of supporting significant weight.

In embodiments, the training system of the present invention can be easily assembled and disassembled for convenient storage. Once unpacked and assembled, the only remaining step is to slide your surfboard into the straps, and learn and practice the Perfect Pop-Up!

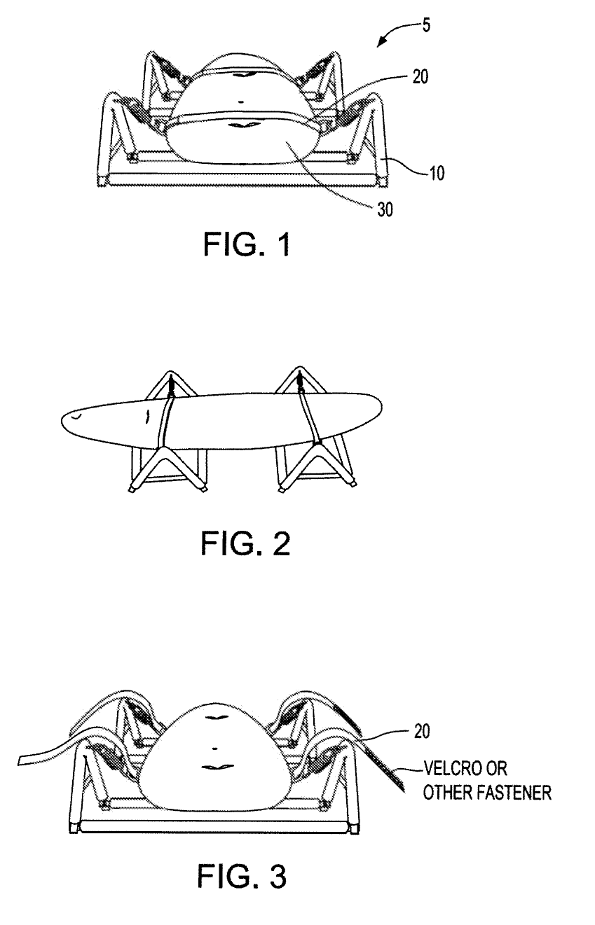

FIGS. 1-3 are views of the training system with a surfboard mounted therein. These views show that the training system 5 comprises two bases 10, with two accompanying straps 20. The straps 20 can be of any material that is of such strength to hold a surfboard 30 within the bases 10, e.g., elevated off the ground. The straps can be fabric or other material, depending on the engineering requirements. The straps 20 can include a fastening device such as, for example, VELCO or other fastener to ensure that the surfboard is securely held within the bases 10, and elevated off of the ground. In FIGS. 1 and 2, the surfboard 30 is shown to be securely fastened in the straps 20; whereas, in FIG. 3, the straps are unfastened with the surfboard 30 laying on top of the opened straps.

As shown in FIGS. 1-3, in embodiments, the surfboard 30 rests on the straps 20, which are attached to the bases 10. The bases are spread apart at such a distance to ensure that the surfboard is able to be stably supported by the straps/base. The bases 10 are also of such a width to ensure that a surfboard 30 can be provided therebetween two uprights, and is of such a height to ensure that the surfboard 30 is elevated off the ground. This will allow the surfboard to be suspended by the straps, with the springs simulating the motion of water.

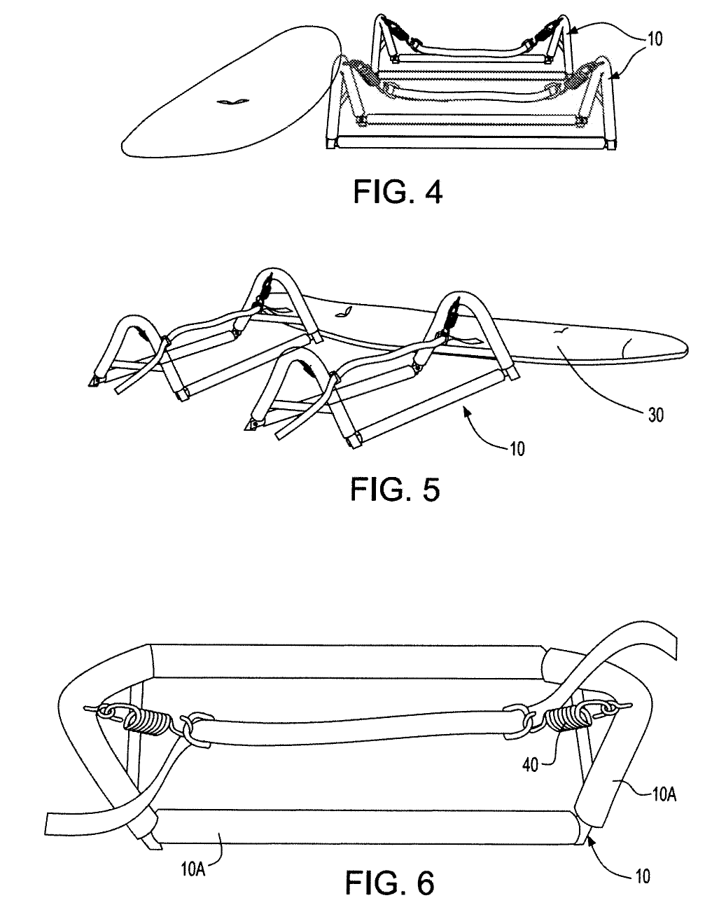

FIGS. 4-5 show the training system without the surfboard 30 mounted therein. In this view, the straps are open.

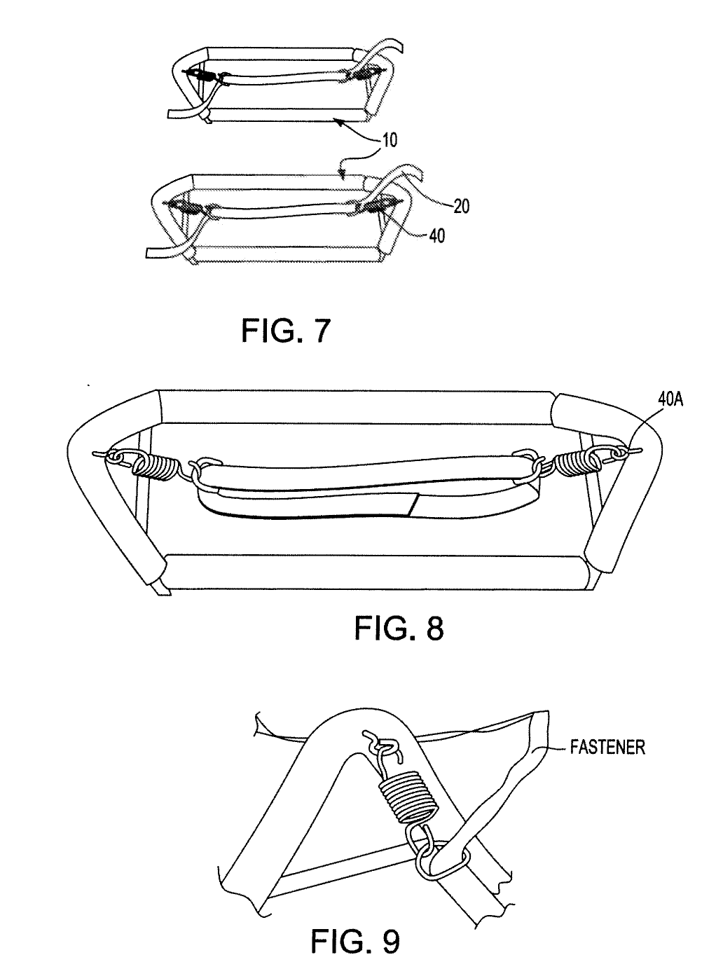

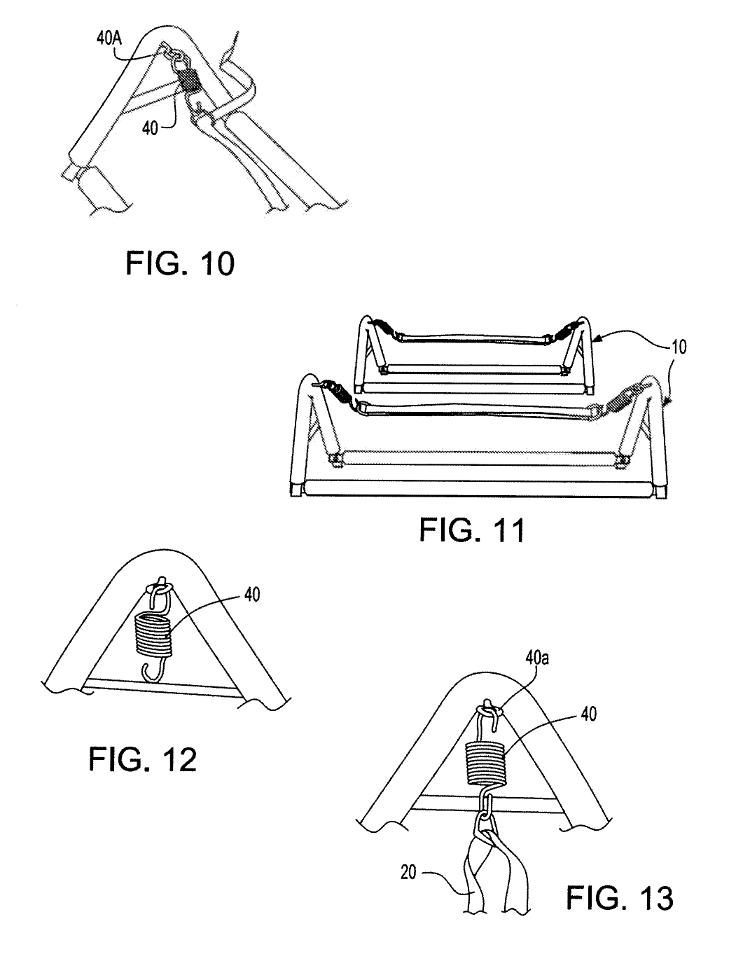

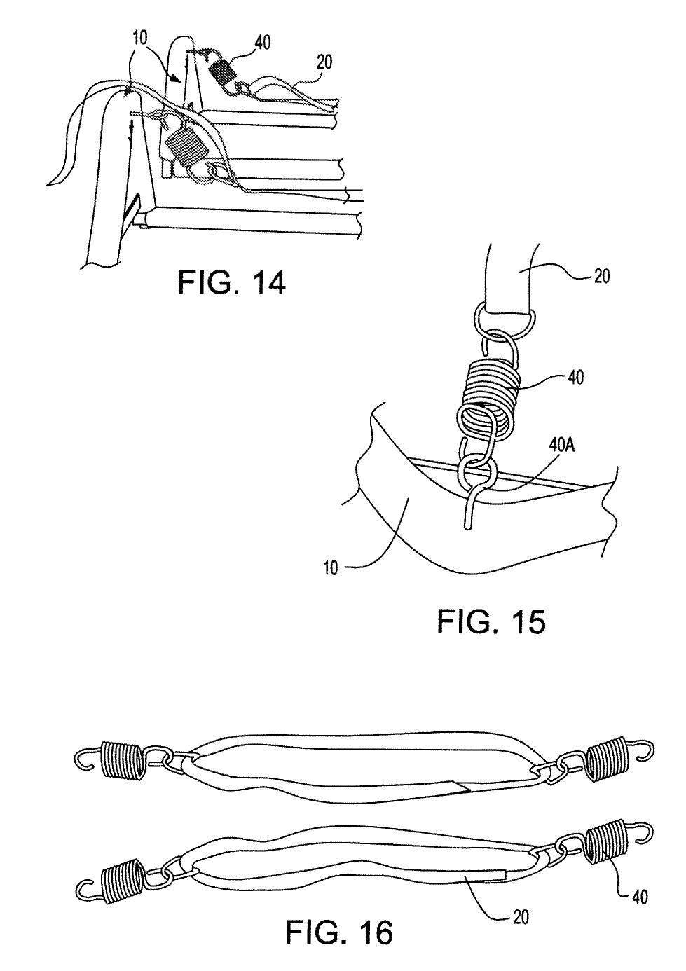

FIGS. 6-15 show various views of the training system and components used with the training system. In embodiments, the base 10 includes padding 10A on the bottom cross bar members, as well as on the upright (side) cross bar members. In embodiments, the padding 10A can be on any combination of the cross bar members.

FIG. 6, in particular, shows a spring 40 mounted between the straps and the upright base members. Those of skill in the art should realize that the present invention is not limited to a spring, but can be any device that provides a spring like effect, e.g., elasticity. This can include, for example, bungee cords or other elastic type materials (e.g., rubber bands). For simplicity, springs will be referred to hereinafter, although the present invention is not intended to be limited to only springs. The springs 40 can be secured to the upright members of the base by an eyelet 40a (FIG. 8) or other fastening mechanism. In embodiments, it is preferred that any such fastening mechanism be capable of allowing the springs to be easily attached and detached for ease of assembly and disassembly. The springs 40 can be fastened to the strap by D-rings or other fastening mechanisms.

FIG. 15 shows an exploded view of the attachment of the strap 20 to the base, via the spring 40 and eyelet 40a. It is contemplated, though, that other mechanisms can be used to secure the strap 20 to the base such as, for example, bolts, cords, etc.

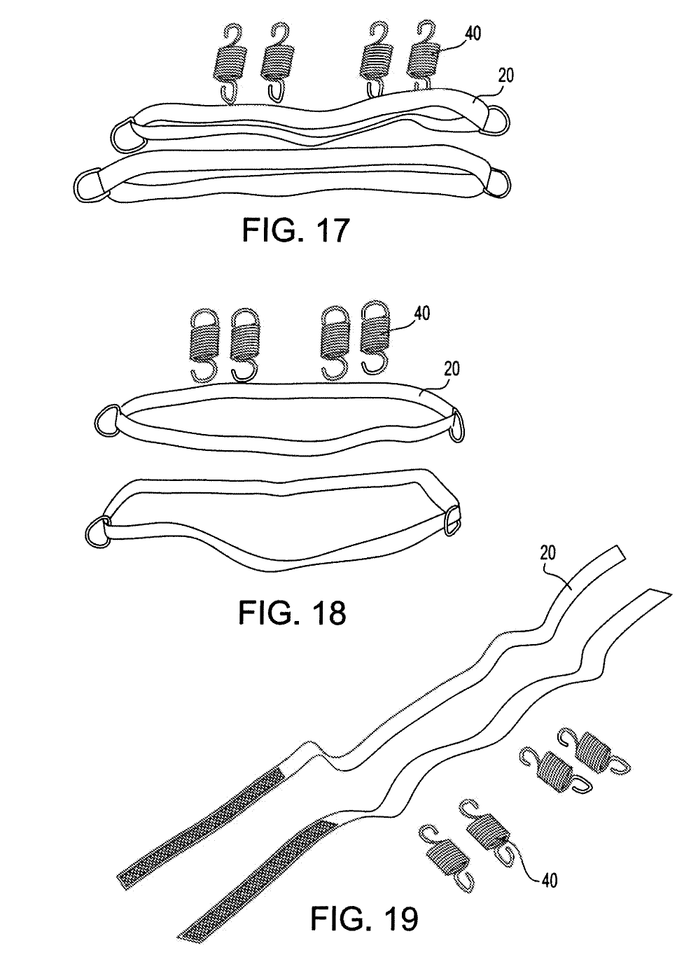

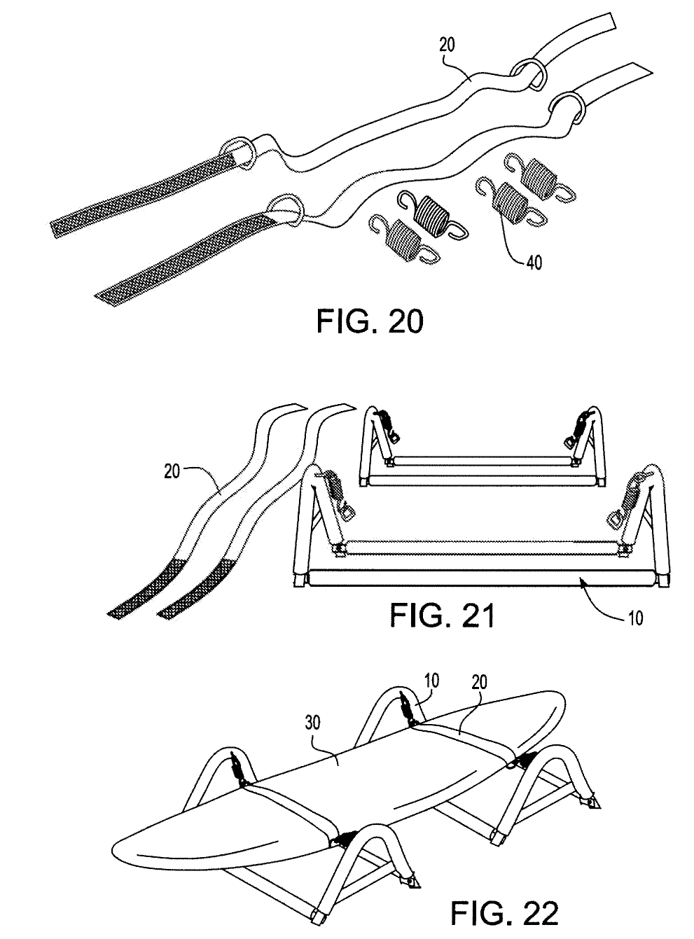

FIGS. 16-21 show various components of the training system. For example, FIG. 16 shows two straps 20 and accompanying springs 40. FIGS. 17-20 show the straps 20 and accompanying springs 40 disassembled. FIG. 21 shows the bases 10 and straps 20, separately. In embodiments, it is preferred that the training system include two straps, bases and springs. In embodiments, the components of the training system such as the straps, bases, four springs, etc. can be sold together or separately as replacement parts or in kits.

Although not to be considered a limiting feature of the present invention, the training system or kit can include the following components, or any combination thereof for the kit or replacement parts.

1. STAND: 1-inch 16 gauge box steel.

2. STRAP AND RELATED COMPONENTS: 1½ inch Heavyweight Polypropylene; stainless steel 1½ inch D-rings; Hook and Loop Velcro 1½ inch.

3. SPRINGS: Stainless 316 Spring/Ultrasonic Passivated per ASTM A967, music wire ASTM A228 or zinc plated per ASTM B 633.

4. PADS: Fabric Imperial 600; PVC Coated 600 Denier Poly Duck.

5. CABLE TIES: 8 inch Intermediate Cable Tie.

6. BUNGEE CORDS, RUBBER BANDS, etc.

Although not to be considered a limiting feature of the present invention, the components of the training system can include the following dimensions:

1. STAND: 36-inch(L)×18-inch (W)×13-inch(H).

2. STRAP (per strap) total of 2 straps per stand:
5-feet total length Heavyweight Polypropylene;
16-inches of 1½-inch Hook and Loop Velcro;
2, 1½ Stainless Steel D-rings (centered 21-inches apart);
2, 1½ Stainless Steel D-rings (centered 19-inches apart); and/or
2, 6-inch length of 1½-inch Heavyweight Polypropylene (this is used to attach D-rings to the strap).

3. PADS:
Bottom Cross Pads: 34 inches long, made of PVC coated 600 Denier Poly Duck.
Side Pads: 24 inches long made of PVC coated 600 Denier Poly Duck

4. HARDWARE:
Stainless Eye-Bolts
Zinc Coated Eye-Bolts
4-inches (L)×1-inch (W)×½ bolt & washer.
5/16 inch×3¼ inches eye-bolt with nut zinc-coated

5. SPRINGS:
Extension Springs
outside diameter=1.750 inch
wire diameter=0.207 inch
max load=216.600 lbs. per spring
free length=4.00 inches
rate=80.20/lbs.
max length=5.845 inches
initial tension=14.590 lbs.
total coils=7.9
number of coils=7.9
finish=zinc plate per ASTM B633

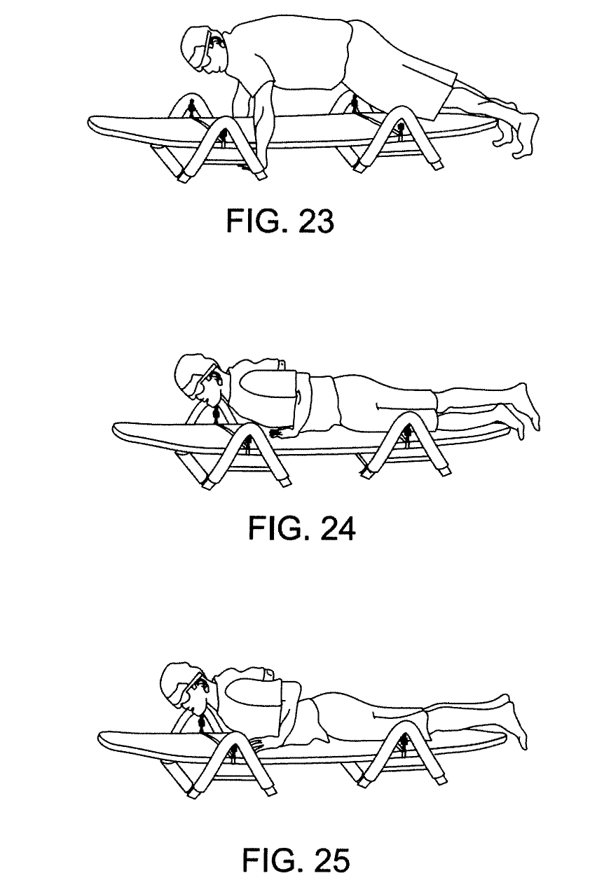

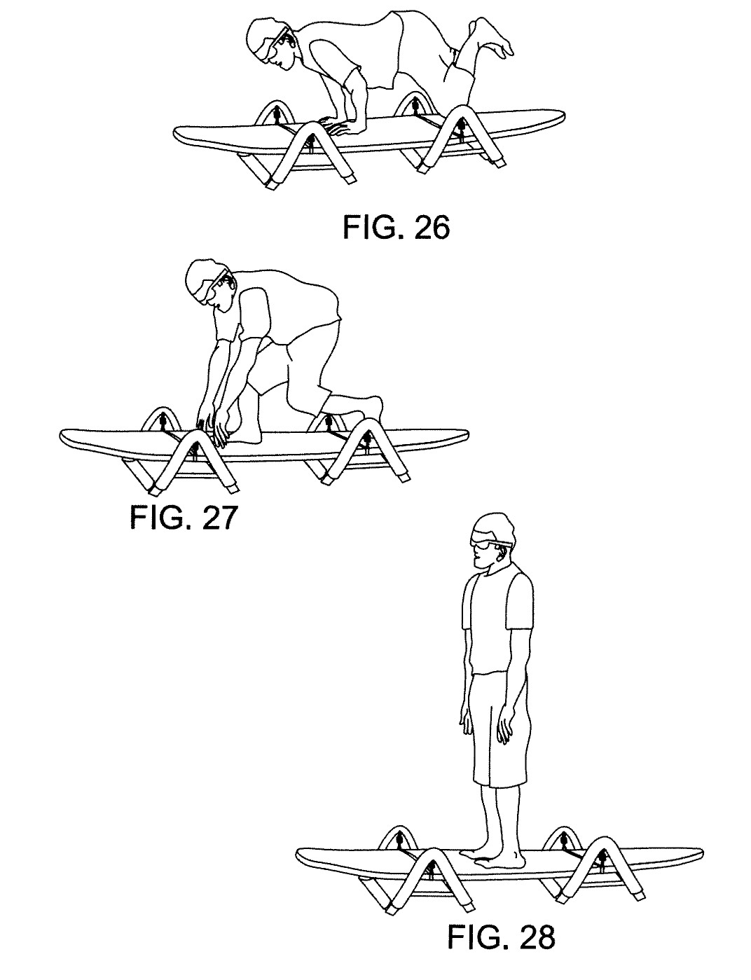

FIGS. 22-28 show a method of using the training system. FIG. 22 shows the surfboard securely fastened within the training system, and elevated off the ground. FIG. 23 shows a user in a beginning position. This includes, for example, straddling the board between the user's arms, with the user's feet at a remote end of the surfboard. The user's feet can also be positioned on opposing sides of the surfboard. In FIG. 24, the user lays on the board, with elbows in an upright position. In this position, the user's legs are flat on the board, with the user's feet preferably extending/hanging over the surfboard. In FIG. 24, the user is preparing to stand upright on the surfboard. In FIG. 26, the user is in a laying or kneeling position, with hands on the surfboard. The hands are in positions that are slightly back on the surfboard, with respect to a previous position. In FIG. 27, the user begins to stand on the surfboard, with one foot in front of another foot. In this position, the user's hands are no longer in contact with the surfboard. In FIG. 28, the user is standing on the surfboard.

During the stages of FIGS. 23-28, the surfboard simulates the motion of water during the stages in which the user is attempting to stand upright on the surfboard. This motion is possible due to the fact that the surfboard is elevated from the ground and is attached to the bases by springs (or other elastic material). The springs, for example, provide the sensation that the surfboard is in water, and it provides a more realistic environment for training, especially during the most difficult task of standing on the surfboard. This is compared to training directly when the surfboard is resting on the ground, in which case, there is no motion to the surfboard.

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

1. A training system for surfers comprising:
bases having dimensions to fit a surf board therebetween; and
straps being fastened to each of the bases by an elastomeric device.

2. The training system of claim 1, wherein portions of the bases are wrapped in padding.

3. The training system of claim 2, wherein the padding is foam.

4. The training system of claim 1, wherein the straps are Polypropylene.

5. The training system of claim 1, wherein the straps are fastened to the elastomeric device.

6. The training system of claim 1, wherein the elastomeric device is one of springs, bungee cords and rubber bands coupled between the straps and the base in order to provide movement of the surf board.

7. The training system of claim 1, wherein the bases are two bases.

8. The training system of claim 1, wherein the straps include a fastening device for securing the surfboard within the bases, and elevated from a surface.

9. The training system of claim 1, wherein the bases include bottom cross bar members and upright members attaching to the bottom cross bar members.

10. The training system of claim 9, wherein padding is on the bottom cross bar members and upright members.

11. The training system of claim 10, wherein the elastomeric device is mounted between the straps and the upright members of each of the bases.

12. The training system of claim 11, wherein the elastomeric device is secured to the upright members by a fastening mechanism.

13. The training system of claim 1, wherein the straps are adjustable to form loops of different sizes.

14. A training system for surfers comprising:
a plurality of bases having upright members and cross members;
a plurality of straps extending between portions of each of the plurality of bases; and
a plurality of stretchable devices attaching each of the plurality of straps to the upright members of respective bases.

15. The training system of claim 14, wherein the stretchable device is a spring.

16. The training system of claim 14, wherein the plurality of straps are adjustable.

17. The training system of claim 14, further comprising pads for placement on the plurality of bases.

18. The training system of claim 14, wherein the plurality of bases are two bases, the plurality of straps are two straps and the plurality of stretchable devices are four springs.

19. A kit, comprising:
two bases having upright members and cross members;
two straps which are configured to extend between portions of each of the plurality of bases; and
four springs or elastomeric devices configured to attach each of the straps to the upright members of the bases.

20. The kit of claim 19, wherein the two straps are adjustable straps.
